(19) United States
(12) Patent Application Publication
(10) Pub. No.: US 2016/0179684 A1
(43) Pub. Date: Jun. 23, 2016

(54) NONVOLATILE MEMORY DEVICE AND OPERATING METHOD THEREOF

(71) Applicant: SK hynix Inc., Gyeonggi-do (KR)

(72) Inventor: Sung-Hyun JUNG, Gyeonggi-do (KR)

(21) Appl. No.: 14/699,748

(22) Filed: Apr. 29, 2015

(30) Foreign Application Priority Data
Dec. 19, 2014 (KR) 10-2014-0184211

(51) Int. Cl. G06F 12/08

(52) U.S. Cl. CPC G06F 12/0871; G06F 2212/1021; G06F 2212/313; G06F 2212/608; G06F 2212/202

(57) ABSTRACT

A nonvolatile memory device may include a memory area suitable for performing a cache operation in response to a command, a memory controller suitable for setting a peak current period in which a current peaks during the cache operation of the memory area, and a command latch unit suitable for receiving the command, transferring the command to the memory controller, and latching a next command and transferring the next command to the memory controller after the peak current period when the next command is received during the peak current period. After a cache operation corresponding to a first peak current period is completed, a next cache operation corresponding to a second peak current period is performed, so that it is possible to reduce the overall peak current.

### CROSS-REFERENCE TO RELATED APPLICATIONS

The present application claims priority of Korean Patent Application No. 10-2014-0184211, filed on Dec. 19, 2014, which is incorporated herein by reference in its entirety.

### BACKGROUND

1. Field

Exemplary embodiments of the present invention relate to a semiconductor design technology and, more particularly, to a nonvolatile memory device that performs a cache operation.

2. Description of the Related Art

FIG. 1 is a block diagram illustrating a general nonvolatile memory device.

Referring to FIG. 1, the nonvolatile memory device includes a host 110, a memory controller 120, and a memory area 130.

The host 110 includes an apparatus such as a computer, a notebook, a digital camera, a cellular phone, a MP3 player, and a portable multimedia player (PMP), and transmits a request for reading or programming data required for its own operation to the memory area 130.

The memory controller 120 is driven in response to a command received from the host 110 and outputs a control signal CTRL for controlling the overall operation of the memory area 130 to the memory area 130. The memory controller 120 outputs data DATA received from the host 110 to the memory area 130 and transfers the data DATA outputted from the memory area 130 to the host 110.

The memory area 130 includes a plurality of memory cells (not illustrated) that store the data DATA. The memory area 130 outputs a busy signal BUSY, which indicates that an operation is being performed therein, to the memory controller 120. The memory area 130 includes a page buffer 131 for temporarily storing the data DATA.

The nonvolatile memory device performs a cache operation such as a cache program operation and a cache read operation.

In the cache program operation, the nonvolatile memory device performs a program operation on a memory cell by using the data DATA previously stored in the page buffer 131, and receives the data DATA for a next cache program operation. The nonvolatile memory device minimizes the time required for the program operation of the memory area 130 through the cache program operation.

Similarly, in the cache read operation, the nonvolatile memory device outputs the data DATA previously stored in the page buffer 131 to outside, and performs a read operation on the memory cell, so that the data DATA for a next cache read operation is stored in the page buffer 131. The nonvolatile memory device minimizes the time required for the read operation of the memory area 130 through the cache read operation.

FIG. 2 is a timing diagram explaining an operation of the nonvolatile memory device illustrated in FIG. 1.

Referring to FIG. 2, the nonvolatile memory device receives a first command CMD1 from outside (e.g., a host or external source) in order to perform the cache operation.

For example, it is assumed that the cache operation of the memory area 130 is the cache program operation.

As the busy signal BUSY outputted from the memory area 130 has a ‘high’ level, the memory controller 120 recognizes that the memory area 130 may perform an operation in response to the first command CMD1.

The memory area 130 receives the data DATA for the cache program operation from the memory controller 120 and stores the data DATA in the page buffer 131. Furthermore, the memory area 130 performs an operation for programming the data DATA stored in the page buffer 131 in the memory cell.

During the cache program operation, when loading word lines and bit lines for the operation for programming the data DATA in the memory cell, that is, when an operation for activating and precharging the word lines and the bit lines is performed, current consumption of the memory area 130 increases. The period in which the current consumption increases due to such an operation is called the first peak period Peak1.

At this time, a second command CMD2 for a next cache program operation is applied to the memory controller 120 from outside. As the busy signal BUSY outputted from the memory area 130 has a ‘high’ level, the memory controller 120 recognizes that the memory area 130 may perform an operation in response to the second command CMD2. When an operation for initializing the page buffer 131 is performed in order to store the data DATA received from outside in response to the second command CMD2, current consumption of the memory area 130 increases. The period in which current consumption increases due to such an operation is called the second peak period Peak2.

As described above, while the memory area 130 is performing the cache program operation corresponding to the first command CMD1, the memory area 130 simultaneously performs the cache program operation corresponding to the second command CMD2. Therefore, in the nonvolatile memory device, the first peak period Peak1 and the second peak period Peak2 overlap each other, resulting in a further increase in the peak current consumed in the cache operation. The memory area 130 for performing a cache operation has to receive the data DATA for a next cache operation in advance while performing an internal operation. That is, the nonvolatile memory device performs an input/output operation of the data DATA for the next cache operation while internally performing the cache operation, resulting in a further increase in the peak current of the memory area 130. When the peak current in the memory area 130 exceeds a reference current amount, which may be supplied from the nonvolatile memory device, operation instability and failure of the nonvolatile memory device may occur.

### SUMMARY

Various embodiments are directed to a nonvolatile memory device for reducing peak current due to cache operations.

In an embodiment, a nonvolatile memory device may include: a memory area suitable for performing a cache operation in response to a command; a memory controller suitable for setting a peak current period in which peak current amount increases during the cache operation of the memory area; and a command latch unit suitable for receiving the command, transferring the command to the memory controller, and latching a next command and transferring the next command to the memory controller after the peak current period, when the next command is received during the peak current period.

Preferably, the memory controller may include: a command decoder suitable for receiving and decoding the command transferred from the command latch unit, and outputting a decoded signal; an operation control unit suitable for generating a control signal for controlling the cache operation of the memory area and information on the peak current period in response to the decoded signal; and a period setting unit suitable for receiving the information on the peak current period, and generating a latch activation signal for controlling the command latch unit.

Preferably, the nonvolatile memory device may further include an interface unit suitable for transferring the command from outside to the command latch unit.

Preferably, the command latch unit may transfer the command to the command decoder when the latch activation signal is deactivated, and latch the command when the latch activation signal is activated.

Preferably, the peak current period may include a current consumption period in which current is consumed in an active and precharge period of a data line during the cache operation of the memory area in response to the command.

In another embodiment, a nonvolatile memory device may include: a memory area suitable for performing a cache operation in response to a command; and a memory controller suitable for setting a peak current period in which peak current amount increases during the cache operation of the memory area, wherein the memory controller comprises: a command control unit suitable for receiving and decoding the command, and generating a flag signal when a next command is applied during the peak current period; and an operation control unit suitable for activating an operation stop signal for a predetermined period in response to the flag signal, wherein the memory controller stops the cache operation of the memory area, which is being currently performed, in response to the operation stop signal, and performs the cache operation in response to the next command.

Preferably, the predetermined period may include a period in which a data input/output operation of the memory area is performed.

Preferably, the operation control unit may generate an operation control signal for controlling the cache operation of the memory area and information on the peak current period in response to a decoded signal from the command control unit.

Preferably, the memory controller may further include a period setting unit suitable for receiving the information on the peak current period, and generating a peak control signal for controlling the command control unit.

Preferably, the nonvolatile memory device may further include an interface unit suitable for transferring the command from outside to the command control unit.

Preferably, the peak current period may include a current consumption period in which current is consumed in an active and precharge period of a data line during the cache operation of the memory area in response to the command.

In another embodiment, a nonvolatile memory device may include: a memory area suitable for performing a cache operation in response to a command in synchronization with an internal clock signal; and a memory controller suitable for setting a first peak current period in which peak current amount increases during the cache operation of the memory area, wherein the memory controller comprises: a command control unit suitable for receiving and decoding the command, and generating a flag signal when a next command is applied during the first peak current period; and a clock control unit suitable for generating a first clock control signal in response to the flag signal, wherein the memory controller may adjust a cycle of the internal clock signal in response to the first clock control signal.

In another embodiment, an operating method of a nonvolatile memory device may include: performing a cache operation in response to a first command; setting a peak current period in which peak current amount increases during the cache operation; latching a second command when the second command is received during the peak current period; and performing a data input/output operation in response to the latched second command after the peak current period.

Preferably, the peak current period may include a current consumption period in which current is consumed in an active and precharge period of a data line during the cache operation.

In another embodiment, an operating method of a nonvolatile memory device may include: performing a cache operation in response to a first command; setting a peak current period in which peak current amount increases during the cache operation; and generating a flag signal when a second command is received during the peak current period.

Preferably, the operating method may further include: stopping the cache operation in response to the flag signal; performing a cache operation corresponding to the second command for a predetermined period in response to the flag signal; and performing the cache operation corresponding to the first command after the predetermined period.

Preferably, the operating method may further include: setting a cycle of a clock signal for a predetermined period in response to the flag signal; performing the cache operation corresponding to the first command and a cache operation corresponding to the second command in response to the set cycle of the clock signal; and resetting the cycle of the clock signal after the predetermined period.

In accordance with the nonvolatile memory device according to embodiments, after a cache operation corresponding to a first peak current period is completed, a next cache operation corresponding to a second peak current period is performed, so that it is possible to reduce the peak current.

Furthermore, after the cache operation corresponding to the first peak current period is stopped and the next cache operation corresponding to the second peak current period is performed, the cache operation corresponding to the first peak current period is performed, so that it is possible to prevent reduce the peak current that is consumed.

Furthermore, a clock cycle of a memory area is changed in a period in which the cache operation corresponding to the first peak current period and the next cache operation corresponding to the second peak current period overlap each other, and the cache operations are performed, so that it is possible to reduce the peak current consumed.

### BRIEF DESCRIPTION OF THE DRAWINGS

FIG. 1 is a block diagram illustrating a general nonvolatile memory device.

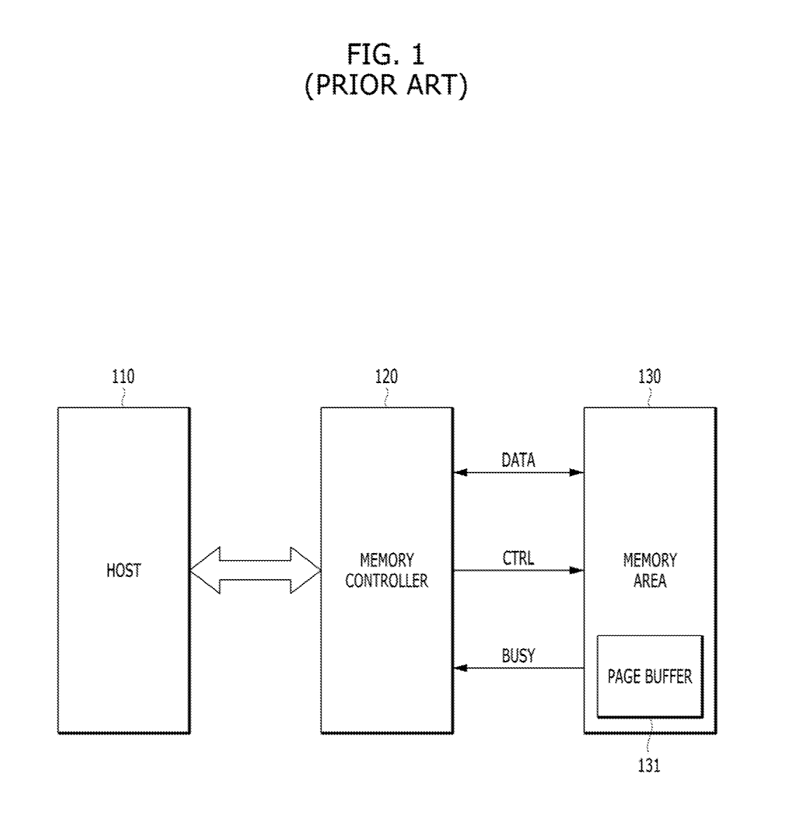

FIG. 2 is a timing diagram explaining an operation of the nonvolatile memory device illustrated in FIG. 1

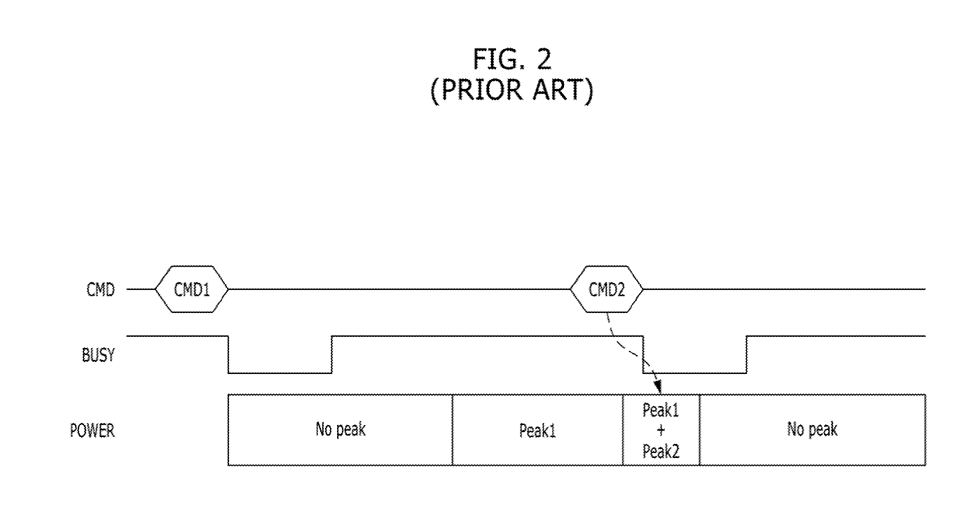

FIG. 3 is a timing diagram explaining an operation of a nonvolatile memory device in accordance with a first embodiment of the present invention.

FIG. 4 is a block diagram illustrating a nonvolatile memory device in accordance with the first embodiment of the present invention.

FIG. 5 is a timing diagram explaining an operation of a nonvolatile memory device in accordance with a second embodiment of the present invention.

FIG. 6 is a block diagram illustrating the nonvolatile memory device in accordance with the second embodiment of the present invention.

FIG. 7 is a timing diagram explaining an operation of a nonvolatile memory device in accordance with a third embodiment of the present invention.

FIG. 8 is a block diagram illustrating the nonvolatile memory device in accordance with the third embodiment of the present invention.

### DETAILED DESCRIPTION

Various embodiments will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

### First Embodiment

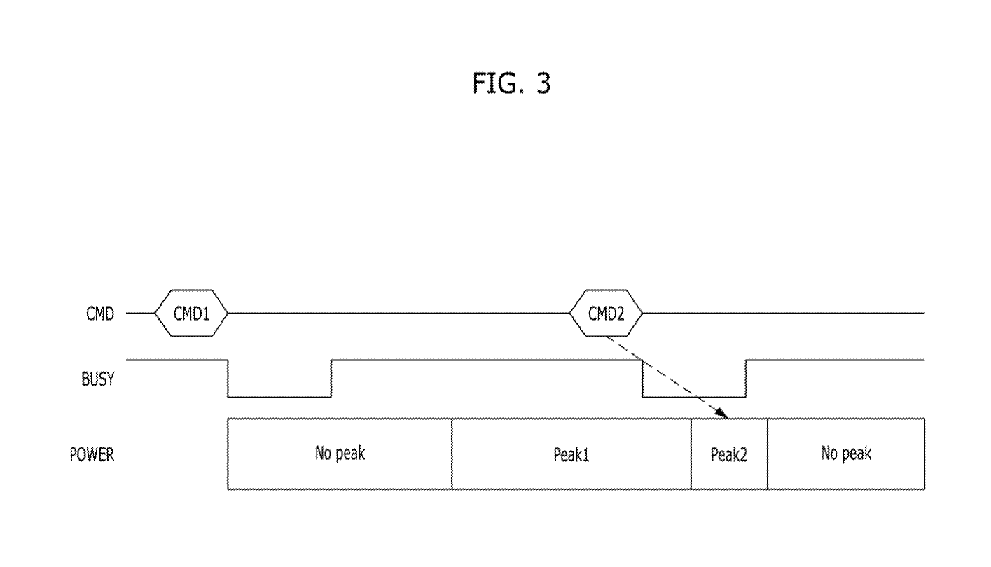

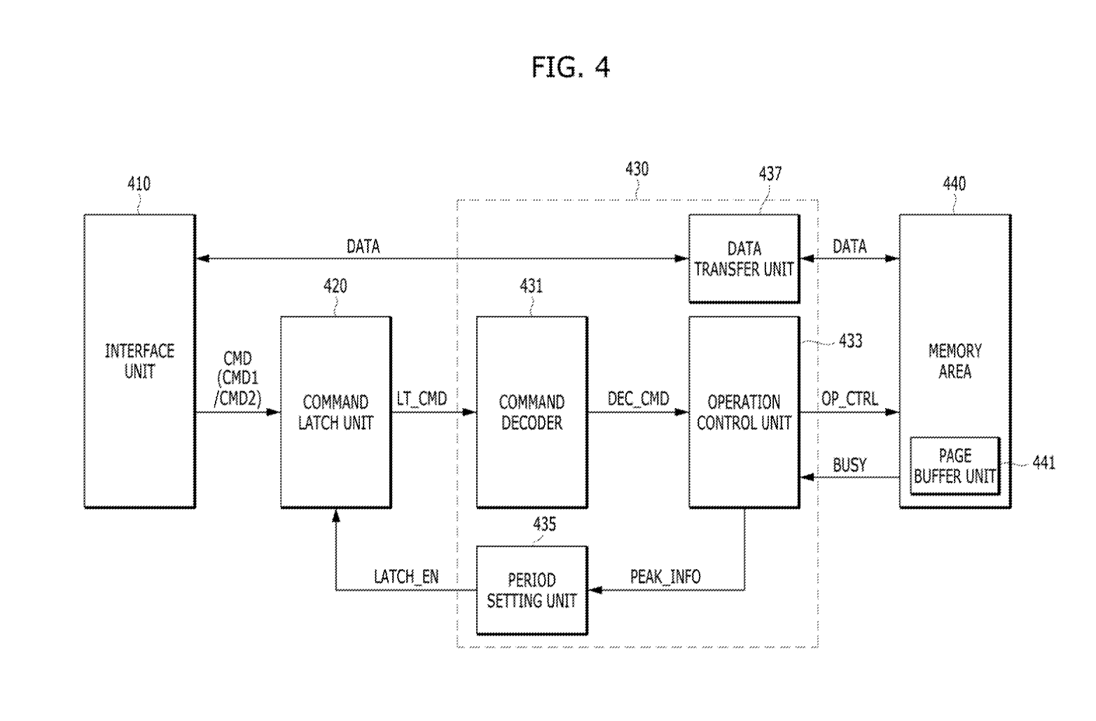

FIG. 3 is a timing diagram explaining a nonvolatile memory device in accordance with a first embodiment of the present invention, and FIG. 4 is a block diagram illustrating the nonvolatile memory device in accordance with the first embodiment of the present invention.

Referring to FIGS. 3 and 4, the nonvolatile memory device may receive a first command CMD1 for performing a cache operation of a memory area 440 from outside. A memory controller 430 may control the cache operation of the memory area 440 in response to a busy signal BUSY of a ‘high’ level outputted from the memory area 440. The memory area 440 may perform the cache operation corresponding to the first command CMD1 in response to an operation control signal OP_CTRL outputted from the memory controller 430.

For example, a cache program operation will be described.

For a cache program operation, the first command CMD1 may be applied to the memory controller 430. The memory area 440 may receive data for the cache program operation of the memory area 440 from the memory controller 430, store the data in a cache latch (not illustrated) of a page buffer unit 441, and program data stored in another cache latch in a memory cell.

Furthermore, the memory controller 430 may set a first peak period Peak1 in which a peak current amount of the memory area 440 increases. The first peak period Peak1 may indicate a loading period of word lines and bit lines of the memory area 440 during the cache program operation.

The nonvolatile memory device may receive a second command CMD2 for performing a next cache program operation of the memory area 440 from outside during the first peak period Peak1. Even though the second command CMD2 is received during the first peak period Peak1, the nonvolatile memory device in accordance with the first embodiment of the present invention may perform the next cache program operation corresponding to the second command CMD2 after the first peak period Peak1 is completed. After the first peak period Peak1 is completed, the memory area 440 may perform the next cache program operation in response to the second command CMD2. The second peak period Peak2 may indicate a peak current period in which peak current is generated by an operation of initializing the cache latch, during a data input/output period in the next cache program operation.

Hereinafter, a cache read operation will be described.

For a cache read operation, the first command CMD1 may be applied to the memory controller 430. The memory area 440 may read data stored in the memory cell to store the data in the cache latch of the page buffer unit 441, and output data stored in another cache latch.

Furthermore, the memory controller 430 may set the first peak period Peak1 in which the peak current amount of the memory area 440 increases. The first peak period Peak1 may indicate a loading period of word lines and bit lines of the memory area 440 during the cache read operation.

The nonvolatile memory device may receive the second command CMD2 for performing a next cache read operation of the memory area 440 from outside during the first peak period Peak1. Even though the second command CMD2 is received during the first peak period Peak1, the nonvolatile memory device in accordance with the first embodiment of the present invention may perform the next cache read operation corresponding to the second command CMD2 after the first peak period Peak1 is completed. The memory area 440 may perform the next cache read operation in response to the second command CMD2. The second peak period Peak2 may indicate a peak current period in which peak current is generated by an operation of outputting the data stored in the cache latch, during the data input/output period in the next cache read operation.

Referring to FIG. 4, the nonvolatile memory device may include an interface unit 410, a command latch unit 420, the memory controller 430, and the memory area 440.

The interface unit 410 may receive data DATA and a command CMD including the first and second commands CMD1 and CMD2 from an external host (not illustrated). The interface unit 410 may output data DATA, which are transferred from the memory area 440, under the control of the host.

The command latch unit 420 may latch and output the command CMD received from the interface unit 410 to the memory controller 430. The command latch unit 420 may store the command CMD in response to a latch activation signal LATCH_EN. The command latch unit 420 may latch the command CMD received from the interface unit 410 to output a latch command LT_CMD to a command decoder 431 included in the memory controller 430 in response to a deactivation of the latch activation signal LATCH_EN. The command latch unit 420 may store the command CMD received from the interface unit 410 in response to an activation of the latch activation signal LATCH_EN.

The memory controller 430 may include the command decoder 431, an operation control unit 433, a period setting unit 435, and a data transfer unit 437.

The command decoder 431 may decode the latch command LT_CMD received from the command latch unit 420. The command decoder 431 may output a decoded signal to the operation control unit 433 as a decoding command DEC_CMD.

The operation control unit 433 may receive the decoding command DEC_CMD from the command decoder 431. The operation control unit 433 may output the operation control signal OP_CTRL for performing a cache operation corresponding to the command CMD to the memory area 440. Furthermore, in response to the decoding command DEC_CMD, the operation control unit 433 may recognize a period in which the peak current amount consumed in the memory area 440 increases. This period may correspond to the first peak period Peak1 described in FIG. 3. The operation control unit 433 may output peak generation information PEAK_INFO, which represents the period in which the peak current amount of the memory area 440 increases, to the period setting unit 435.

The period setting unit 435 may receive the peak generation information PEAK_INFO from the operation control unit 433. Based on the peak generation information PEAK_INFO, the period setting unit 435 may output the latch activation signal LATCH_EN to the command latch unit 420.

The data transfer unit 437 may transfer the data DATA received from the interface unit 410 to the memory area 440 during the cache program operation, and may transfer the data DATA outputted from the memory area 440 to the interface unit 410 during the cache read operation.

The memory area 440 may include a plurality of memory cells (not illustrated) and the page buffer unit 441. The page buffer unit 441 may include a plurality of page buffers (not illustrated) coupled to the memory cells to temporarily store data. Each of the plurality of page buffers may include the cache latch (not illustrated) for the cache operation. The memory area 440 may include busy signal generation unit (not Illustrated) to generate the busy signal BUSY. The busy signal generation unit may identify the cache latch of the plurality of page buffers and generate the busy signal BUSY of a ‘high’ level when the cache latch is capable of storing the data DATA. The busy signal generation unit may out the busy signal BUSY to the operation control unit 433.

The memory area 440 may perform the cache operation in response to the operation control signal OP_CTRL.

Next, a cache program operation of the nonvolatile memory device in accordance with the first embodiment of the present invention will be described.

The interface unit 410 may receive the first command CMD1 from outside and transfer the first command CMD1 to the command latch unit 420. The command latch unit 420 may output the first command CMD1 as the latch command LT_CMD in response to the deactivation of the latch activation signal LATCH_EN. The command decoder 431 may decode the latch command LT_CMD and output the decoding command DEC_CMD. The operation control unit 433 may receive the decoding command DEC_CMD, generate the operation control signal OP_CTRL, and output the operation control signal OP_CTRL to the memory area 440. In response to the decoding command DEC_CMD, the operation control unit 433 may output the peak generation information PEAK_INFO to the period setting unit 435. Based on the peak generation information PEAK_INFO, the period setting unit 435 may activate the latch activation signal LATCH_EN for a period corresponding to the peak generation information PEAK_INFO. The peak generation information PEAK_INFO may represent the first peak period Peak1 indicating the loading period of the word lines and the bit lines coupled to the plurality of memory cells of the memory area 440 during the cache program operation corresponding to the first command CMD1.

The data transfer unit 437 may transfer the data DATA received from the interface unit 410 to the memory area 440. The memory area 440 may program the data DATA stored in the cache latch in the memory cell in response to the operation control signal OP_CTRL.

During the cache program operation, when the peak current amount increases, the second command CMD2 for the next cache program operation may be received in the command latch unit 420. The command latch unit 420 may store the second command CMD2 in response to the activation of the latch activation signal LATCH_EN.

Then, when the period in which the peak current amount increases is completed during the cache program operation corresponding to the first command CMD1, the period setting unit 435 may deactivate the latch activation signal LATCH_EN. In response to the deactivation of the latch activation signal LATCH_EN, the command latch unit 420 may output the stored second command CMD2 as the latch command LT_CMD. Then, a cache program operation of the memory controller 430 and the memory area 440 in response to the second command CMD2 may be substantially the same as the cache program operation in response to the first command CMD1.

When the second command CMD2 is received while the cache program operation corresponding to the first command CMD1 is being performed, the nonvolatile memory device may perform the next cache program operation corresponding to the second command CMD2 after the first peak period Peak1 is completed.

Consequently, since the nonvolatile memory device performs the cache program operation corresponding to the second command CMD2 after the first peak period Peak1 is completed, it is possible to reduce the peak current consumed in the cache operation.

Hereinafter, an example in which the nonvolatile memory device performs a cache read operation will be described.

The interface unit 410 may receive the first command CMD1 from outside and transfer the first command CMD1 to the command latch unit 420. The command latch unit 420 may output the first command CMD1 as the latch command LT_CMD in response to the deactivation of the latch activation signal LATCH_EN. The command decoder 431 may decode the latch command LT_CMD and output the decoding command DEC_CMD. The operation control unit 433 may receive the decoding command DEC_CMD and output the operation control signal OP_CTRL to the memory area 440. In response to the decoding command DEC_CMD, the operation control unit 433 may output the peak generation information PEAK_INFO to the period setting unit 435. Based on the peak generation information PEAK_INFO, the period setting unit 435 may activate the latch activation signal LATCH_EN for a period corresponding to the peak generation information PEAK_INFO. At this time, the peak generation information PEAK_INFO may represent the first peak period Peak1 indicating the loading period of the word lines and the bit lines coupled to the plurality of memory cells of the memory area 440 during the cache read operation corresponding to the first command CMD1.

The memory area 440 may read data DATA stored in the memory cell in response to the operation control signal OP_CTRL. The read data may be stored in the cache latch. The data transfer unit 437 may receive data DATA stored in the cache latch of the memory area 440 and transfer the data DATA to the interface unit 410.

During the cache read operation, when the peak current amount increases, the second command CMD2 for the next cache read operation may be received in the command latch unit 420. The command latch unit 420 may store the second command CMD2 in response to the activation of the latch activation signal LATCH_EN.

Then, when the period in which the peak current amount increases is completed during the cache read operation corresponding to the first command CMD1, the period setting unit 435 may deactivate the latch activation signal LATCH_EN. In response to the deactivation of the latch activation signal LATCH_EN, the command latch unit 420 may output the stored second command CMD2 as the latch command LT_CMD. Then, a cache read operation of the memory controller 430 and the memory area 440 in response to the second command CMD2 may be substantially the same as the cache read operation in response to the first command CMD1.

When the second command CMD2 is received while the cache read operation corresponding to the first command CMD1 is being performed, the nonvolatile memory device may perform the next cache read operation corresponding to the second command CMD2 after the first peak period Peak1 is completed.

Consequently, since the nonvolatile memory device performs the next cache read operation corresponding to the second command CMD2 after the first peak period Peak1, it is possible to reduce the current consumed in the cache operation.

### Second Embodiment

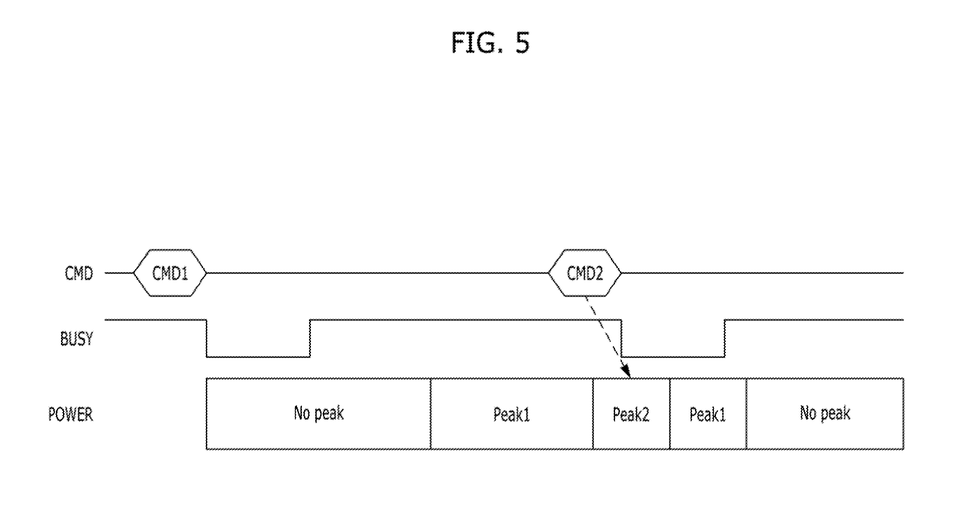

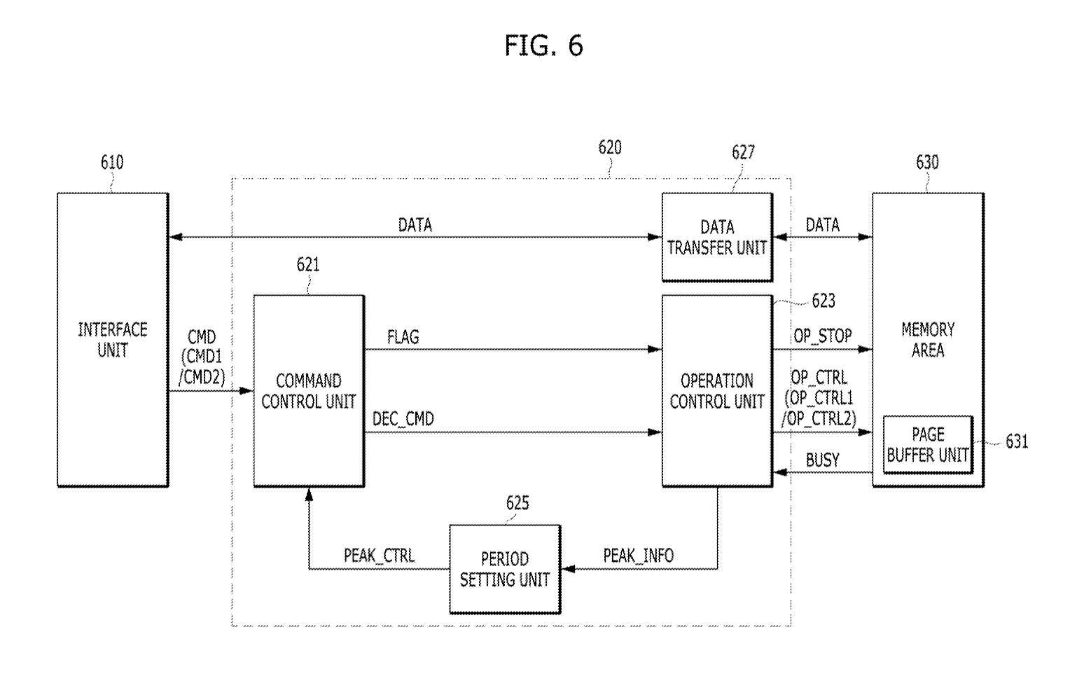

FIG. 5 is a timing diagram explaining a nonvolatile memory device in accordance with a second embodiment of the present invention, and FIG. 6 is a block diagram illustrating the nonvolatile memory device in accordance with the second embodiment of the present invention.

Referring to FIGS. 5 and 6, the nonvolatile memory device may receive a first command CMD1 for performing a cache operation of a memory area 630 from outside. A memory controller 620 may control the cache operation of the memory area 630 in response to a busy signal BUSY of a ‘high’ level outputted from the memory area 630. The memory area 630 may perform the cache operation corresponding to the first command CMD1 in response to an operation control signal OP_CTRL outputted from the memory controller 620.

For example, a cache program operation will be described.

For a cache program operation, the first command CMD1 may be applied to the memory controller 620. The memory area 630 may receive data for the cache program operation of the memory area 630 from the memory controller 620, store the data in a cache latch (not illustrated) of a page buffer unit 631, and program data stored in another cache latch in a memory cell.

Furthermore, the memory controller 620 may set a first peak period Peak1 in which a peak current amount of the memory area 630 increases. The first peak period Peak1 may indicate a loading period of word lines and bit lines of the memory area 630 during the cache program operation.

The nonvolatile memory device may receive a second command CMD2 for performing a next cache program operation of the memory area 630 from outside during the first peak period Peak1. When the second command CMD2 is received during the first peak period Peak1, the nonvolatile memory device in accordance with the second embodiment of the present invention may stop the cache operation corresponding to the first peak period Peak1 and may perform the cache operation corresponding to the second command CMD2. The memory area 630 may perform the next cache program operation in response to the second command CMD2. The second peak period Peak2 is a period previously set in the memory controller 620 during the next cache program operation, and may indicate a data input/output period of the memory area 630. That is, the second peak period Peak2 may indicate a peak current period in which peak current is generated by an operation of initializing the cache latch of the memory area 630.

After the second peak period Peak2 is completed, the nonvolatile memory device may perform the cache operation corresponding to the first peak period Peak1 again. Consequently, since the nonvolatile memory device distributes the first peak period Peak1 and the second peak period Peak2, it is possible to reduce the peak current consumed in the cache operation.

Hereinafter, a cache read operation will be described.

For a cache read operation, the first command CMD1 may be applied to the memory controller 620. The memory area 630 may read data stored in the memory cell to store the data in the cache latch of the page buffer unit 631, and output data stored in another cache latch.

Furthermore, the memory controller 620 may set the first peak period Peak1 in which the peak current amount of the memory area 630 increases. The first peak period Peak1 may indicate a loading period of word lines and bit lines of the memory area 630 during the cache read operation.

The nonvolatile memory device may receive the second command CMD2 for performing a next cache read operation of the memory area 630 from outside during the first peak period Peak1. When the second command CMD2 is received during the first peak period Peak1, the nonvolatile memory device in accordance with the second embodiment of the present invention may stop the cache read operation corresponding to the first peak period Peak1 and may perform the cache read operation corresponding to the second command CMD2. The memory area 630 may perform the next cache read operation in response to the second command CMD2. The second peak period Peak2 is a period previously set in the memory controller 620 during the next cache read operation, and may indicate the data input/output period of the memory area 630. That is, the second peak period Peak2 may indicate a peak current period in which peak current is generated by an operation of outputting data stored in the cache latch of the memory area 630.

The nonvolatile memory device may perform the cache operation corresponding to the first peak period Peak1 again after the second peak period Peak2 is completed. Consequently, since the nonvolatile memory device distributes the first peak period Peak1 and the second peak period Peak2, it is possible to reduce the peak current consumed in the cache operation.

Referring to FIG. 6, the nonvolatile memory device may include an interface unit 610, the memory controller 620, and the memory area 630.

The interface unit 610 may receive data DATA and a command CMD including the first and second commands CMD1 and CMD2 from an external host (not illustrated). The interface unit 610 may output data DATA, which are transferred from the memory area 630, under the control of the host.

The memory controller 620 may include a command control unit 621, an operation control unit 623, a period setting unit 625, and a data transfer unit 627.

The command control unit 621 may decode the command CMD received from the interface unit 610 and output a decoding command DEC_CMD. The command control unit 621 may generate a flag signal FLAG in response to a peak control signal PEAK_CTRL received from the period setting unit 625. The command control unit 621 may output the decoding command DEC_CMD and the flag signal FLAG to the operation control unit 623.

In response to the decoding command DEC_CMD, the operation control unit 623 may output the operation control signal OP_CTRL for performing a cache operation corresponding to the command CMD to the memory area 630. For reference, the operation control signal OP_CTRL includes a first operation control signal OP_CTRL1 corresponding to the first command CMD1 and a second operation control signal OP_CTRL2 corresponding to the second command CMD2. In response to the flag signal FLAG, the operation control unit 623 may output an operation stop signal OP_STOP. In response to the decoding command DEC_CMD, the operation control unit 623 may recognize a period in which the peak current amount consumed in the memory area 630 increases. This period may correspond to the first peak period Peak1 described in FIG. 5. The operation control unit 623 may output peak generation information PEAK_INFO, which represents the period in which the peak current amount of the memory area 630 increases, to the period setting unit 625.

The operation control unit 623 may include a register (not illustrated). The register may store information on a period in which a data input/output operation of the memory area 630 is performed in response to the command CMD, i.e., the data input/output period. This period may correspond to the second peak period Peak2 described in FIG. 5. The operation control unit 623 may activate the operation stop signal OP_STOP in response to an activation of the flag signal FLAG. Furthermore, the operation control unit 623 may receive the information on the data input/output period stored in the register, and maintain the operation stop signal OP_STOP in the activated state for the data input/output period.

The period setting unit 625 may receive the peak generation information PEAK_INFO from the operation control unit 623. Based on the peak generation information PEAK_INFO, the period setting unit 625 may output the peak control signal PEAK_CTRL to the command control unit 621.

The data transfer unit 627 may transfer the data DATA received from the Interface unit 610 to the memory area 630 during the cache program operation, and may transfer the data DATA outputted from the memory area 630 to the interface unit 610 during the cache read operation.

The memory area 630 may include a plurality of memory cells (not illustrated) and the page buffer unit 631. The page buffer unit 631 may include a plurality of page buffers (not illustrated) coupled to the memory cells to temporarily store data. Each of the plurality of page buffers may include the cache latch (not illustrated) for the cache operation. The memory area 630 may include busy signal generation unit (not illustrated) to generate the busy signal BUSY. The busy signal generation unit may identify the cache latch of the plurality of page buffers and generate the busy signal BUSY of a ‘high’ level when the cache latch is capable of storing the data DATA. The busy signal generation unit may out the busy signal BUSY to the operation control unit 623.

The memory area 630 may perform the cache operation in response to the operation control signal OP_CTRL. The memory area 630 may stop an operation being currently performed in response to the operation stop signal OP_STOP.

Next, an operation of the nonvolatile memory device in accordance with the second embodiment of the present invention will be described.

For example, the nonvolatile memory device performing a cache program operation will be described.

The interface unit 610 may receive the first command CMD1 from outside and transfer the first command CMD1 to the command control unit 621. The command control unit 621 may decode the first command CMD1 in response to a deactivation of the peak control signal PEAK_CTRL. The command control unit 621 may output a decoded signal to the operation control unit 623 as the decoding command DEC_CMD. In response to the decoding command DEC_CMD, the operation control unit 623 may output the first operation control signal OP_CTRL1 to the memory area 630. In response to the decoding command DEC_CMD, the operation control unit 623 may output the peak generation information PEAK_INFO to the period setting unit 625.

Based on the peak generation information PEAK_INFO, the period setting unit 625 may activate the peak control signal PEAK_CTRL for a period corresponding to the peak generation information PEAK_INFO. The peak generation information PEAK_INFO may represent the first peak period Peak1 indicating the loading period of the word lines and the bit lines coupled to the plurality of memory cells of the memory area 630 during the cache program operation corresponding to the first command CMD1.

The data transfer unit 627 may transfer the data DATA received from the interface unit 610 to the memory area 630. The memory area 630 may program the data DATA stored in the cache latch in the memory cell in response to the first operation control signal OP_CTRL1.

During the cache program operation, when the peak current amount increases, the second command CMD2 for the next cache program operation may be received in the command control unit 621.

The command control unit 621 may activate the flag signal FLAG in response to an activation of the peak control signal PEAK_CTRL and the second command CMD2. The command control unit 621 may decode the second command CMD2 and output the decoding command DEC_CMD. The operation control unit 623 may receive the activated flag signal FLAG and the decoding command DEC_CMD. The operation control unit 623 may receive the Information on the data input/output period corresponding to the decoding command DEC_CMD from the register (not illustrated). In response to the activation of the flag signal FLAG, the operation control unit 623 may activate the operation stop signal OP_STOP, and may maintain the operation stop signal OP_STOP in the activated state for the data input/output period. In response to the decoding command DEC_CMD, the operation control unit 623 may output the second operation control signal OP_CTRL2 to the memory area 630.

In response to an activation of the operation stop signal OP_STOP, the memory area 630 may stop the program operation being performed. In response to the second operation control signal OP_CTRL2, the memory area 630 may receive data DATA to be stored in the cache latch from the data transfer unit 627.

After the data input/output period of the memory area 630 is completed, the operation control unit 623 may deactivate the operation stop signal OP_STOP. In response to a deactivation of the operation stop signal OP_STOP, the memory area 630 may perform the cache program operation corresponding to the first command CMD1 again, which is stopped in response to the deactivation of the operation stop signal OP_STOP.

When the second command CMD2 is received while the cache program operation corresponding to the first command CMD1 is being performed, the nonvolatile memory device may stop the cache program operation corresponding to the first command CMD1, and perform the data input/output operation during the next cache program operation corresponding to the second command CMD2. After the operation for initializing the cache latch is completed during the data input/output operation, the nonvolatile memory device may perform the cache program operation corresponding to the first command CMD1. Consequently, since the nonvolatile memory device distributes peak periods generated in the cache program operation corresponding to the first command CMD1 and the next cache program operation corresponding to the second command CMD2, it is possible to reduce the peak current of the nonvolatile memory device.

Hereinafter, the nonvolatile memory device performing a cache read operation will be described.

The interface unit 610 may receive the first command CMD1 from outside and transfer the first command CMD1 to the command control unit 621. The command control unit 621 may decode the first command CMD1 and output the decoding command DEC_CMD in response to the deactivation of the peak control signal PEAK_CTRL. The operation control unit 623 may receive the decoding command DEC_CMD. In response to the decoding command DEC_CMD, the operation control unit 623 may output the first operation control signal OP_CTRL1 to the memory area 630. In response to the decoding command DEC_CMD, the operation control unit 623 may output the peak generation information PEAK_INFO to the period setting unit 625.

Based on the peak generation Information PEAK_INFO, the period setting unit 625 may activate the peak control signal PEAK_CTRL for a period corresponding to the peak generation information PEAK_INFO. The peak generation information PEAK_INFO may represent the first peak period Peak1 indicating the loading period of the word lines and the bit lines coupled to the plurality of memory cells of the memory area 630 during the cache read operation corresponding to the first command CMD1.

In response to the first operation control signal OP_CTRL1, the memory area 630 may read data DATA stored in the plurality of cells of the memory area 630. The read data may be stored in the cache latch. The data transfer unit 627 may receive the data DATA stored in the cache latch of the memory area 630 and transfer the data DATA to the interface unit 610.

During the cache read operation, when the peak current amount increases, the second command CMD2 for the next cache read operation may be received in the command control unit 621.

The command control unit 621 may activate the flag signal FLAG in response to the activation of the peak control signal PEAK_CTRL and the second command CMD2. The command control unit 621 may decode the second command CMD2 and output the decoding command DEC_CMD. The operation control unit 623 may receive the activated flag signal FLAG and the decoding command DEC_CMD. The operation control unit 623 may receive the information on the data input/output period of the memory area 630 corresponding to the decoding command DEC_CMD from the register (not illustrated). In response to the activation of the flag signal FLAG, the operation control unit 623 may activate the operation stop signal OP_STOP, and may maintain the operation stop signal OP_STOP in the activated state for the data input/output period. In response to the decoding command DEC_CMD, the operation control unit 623 may output the second operation control signal OP_CTRL2 to the memory area 630.

In response to the activation of the operation stop signal OP_STOP, the memory area 630 may stop the cache read operation being performed. In response to the second operation control signal OP_CTRL2, the memory area 630 may output previous data DATA stored in the cache latch of the memory area 630.

After the data input/output period of the memory area 630 is completed, the operation control unit 623 may deactivate the operation stop signal OP_STOP. In response to the deactivation of the operation stop signal OP_STOP, the memory area 630 may perform the cache read operation corresponding to the first command CMD1 again, which is stopped in response to the deactivation of the operation stop signal OP_STOP.

When the second command CMD2 is received while the cache read operation corresponding to the first command CMD1 is being performed, the nonvolatile memory device may stop the cache read operation corresponding to the first command CMD1, and perform the data input/output operation during the next cache read operation corresponding to the second command CMD2. After the operation for outputting previous data DATA stored in the cache latch during the data input/output operation, the nonvolatile memory device may perform the cache read operation corresponding to the first command CMD1. Consequently, since the nonvolatile memory device distributes peak periods generated in the cache read operation corresponding to the first command CMD1 and the next cache read operation corresponding to the second command CMD2, it is possible to reduce the peak current consumed.

### Third Embodiment

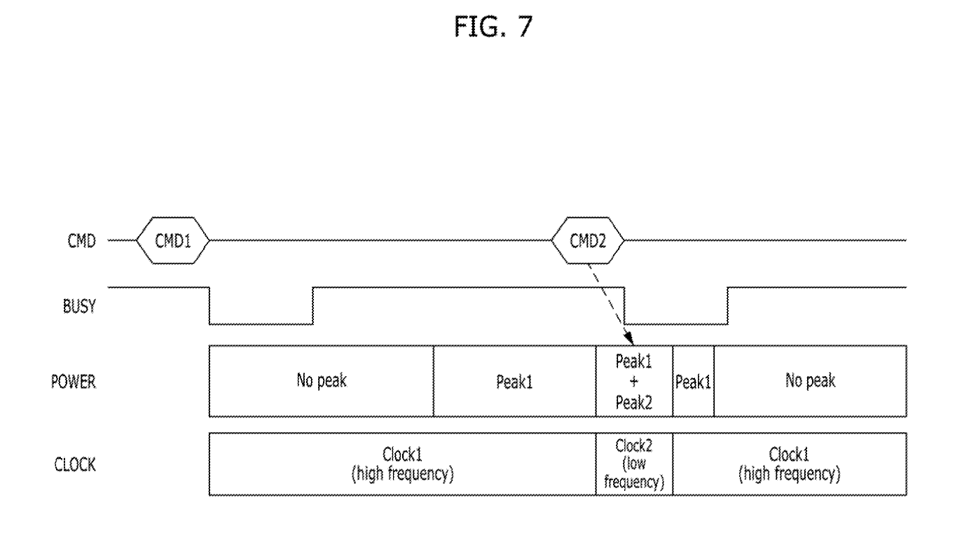

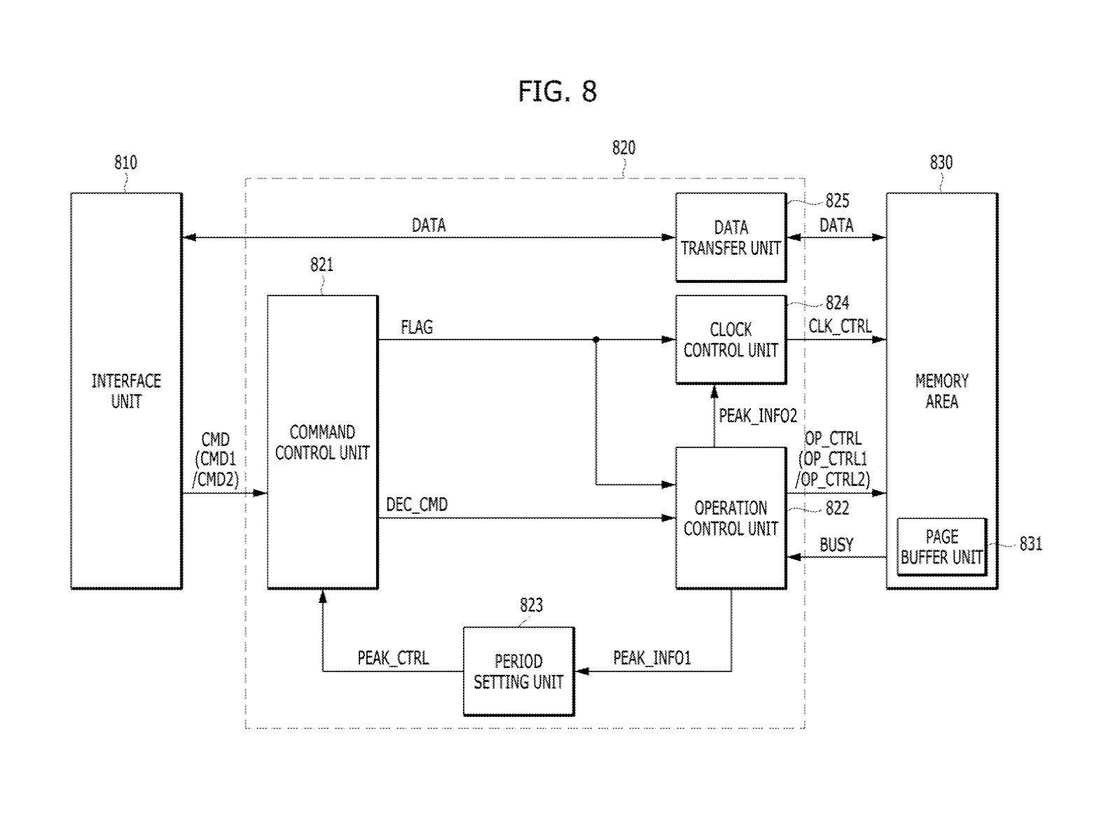

FIG. 7 is a timing diagram explaining a nonvolatile memory device in accordance with a third embodiment of the present invention, and FIG. 8 is a block diagram illustrating the nonvolatile memory device in accordance with the third embodiment of the present invention.

Referring to FIGS. 7 and 8, the nonvolatile memory device may receive a first command CMD1 for performing a cache operation of a memory area 830 from outside. A memory controller 820 may control the cache operation of the memory area 830 in response to a busy signal BUSY of a ‘high’ level outputted from the memory area 830. The memory area 830 may perform the cache operation corresponding to the first command CMD1 in response to an operation control signal OP_CTRL outputted from the memory controller 820.

For example, a cache program operation will be described.

For the cache program operation, the first command CMD1 may be applied to the memory controller 820. The memory area 830 may receive data for the cache program operation of the memory area 830 from the memory controller 820, store the data in a cache latch (not illustrated) of a page buffer unit 831, and program data stored in another cache latch in a memory cell.

Furthermore, the memory controller 820 may set a first peak period Peak1 in which a peak current amount of the memory area 830 increases. The first peak period Peak1 may indicate a loading period of word lines and bit lines of the memory area 830 during the cache program operation.

The nonvolatile memory device may receive a second command CMD2 for performing a next cache program operation of the memory area 830 from outside during the first peak period Peak1. When the second command CMD2 is received during the first peak period Peak1, the nonvolatile memory device in accordance with the third embodiment of the present invention may perform the cache program operation by changing a cycle of an internal clock signal of the memory area 830. The memory area 830 may perform the cache program operation corresponding to the first command CMD1 and the next cache program operation corresponding to the second command CMD2 according to the changed cycle of the internal clock signal. The second peak period Peak2 is a period set in the memory controller 820 during the next cache program operation, and may indicate a data input/output period of the memory area 830. That is, the second peak period Peak2 may indicate a peak current period in which peak current is generated by an operation of initializing the cache latch, during the data input/output period.

Consequently, the nonvolatile memory device may change a clock cycle of the memory area to reduce its frequency (i.e. Increase its period) and perform the cache program operations corresponding to the first and second command CMD1 and CMD2, thereby reducing the peak current consumed.

Hereinafter, a cache read operation will be described.

For the cache read operation, the first command CMD1 may be applied to the memory controller 820. The memory area 830 may read data stored in the memory cell to store the data in the cache latch of the page buffer unit 831, and output data stored in another cache latch.

Furthermore, the memory controller 820 may set the first peak period Peak1 in which the peak current amount of the memory area 830 increases. The first peak period Peak1 may indicate a loading period of word lines and bit lines of the memory area 830 during the cache read operation.

The nonvolatile memory device may receive the second command CMD2 for performing a next cache read operation of the memory area 830 from outside during the first peak period Peak1. When the second command CMD2 is received during the first peak period Peak1, the nonvolatile memory device in accordance with the third embodiment of the present invention may change the clock cycle of the memory area 830. The memory area 830 may perform the cache read operation corresponding to the first command CMD1 and the next cache read operation corresponding to the second command CMD2 according to the changed clock cycle. The second peak period Peak2 is a period set in the memory controller 820 during the next cache operation, and may indicate the data input/output period of the memory area 830. That is, the second peak period Peak2 may indicate a peak current period in which peak current is generated by an operation of outputting data stored in the cache latch, during the data input/output period.

Consequently, the nonvolatile memory device may change the clock cycle of the memory area 830 to reduce its frequency and perform the cache read operation corresponding to the first and second command CMD1 and CMD2, thereby reducing the peak current consumed.

Referring to FIG. 8, the nonvolatile memory device may include an interface unit 810, the memory controller 820, and the memory area 830.

The interface unit 810 may receive data DATA and a command CMD including the first and second commands CMD1 and CMD2 from an external host (not illustrated). The Interface unit 810 may output data DATA, which are transferred from the memory area 830, under the control of the host.

The memory controller 820 may include a command control unit 821, an operation control unit 822, a period setting unit 823, a clock control unit 824, and a data transfer unit 825.

The command control unit 821 may decode the command CMD received from the Interface unit 810 and output a decoding command DEC_CMD. The command control unit 821 may generate a flag signal FLAG in response to a peak control signal PEAK_CTRL received from the period setting unit 823. The command control unit 821 may output the decoding command DEC_CMD to the operation control unit 822. The command control unit 821 may output the flag signal FLAG to the clock control unit 824.

The operation control unit 822 may receive the decoding command DEC_CMD from the command control unit 821. The operation control unit 822 may output the operation control signal OP_CTRL for performing a cache operation corresponding to the command CMD to the memory area 830. For reference, the operation control signal OP_CTRL includes a first operation control signal OP_CTRL1 corresponding to the first command CMD1 and a second operation control signal OP_CTRL2 corresponding to the second command CMD2. In response to the decoding command DEC_CMD, the operation control unit 822 may recognize a period in which the peak current amount consumed in the memory area 830 increases. This period may correspond to the first peak period Peak1 described in FIG. 7. The operation control unit 822 may output first peak generation information PEAK_INFO1, which represents the period in which the peak current amount of the memory area 830 increases, to the period setting unit 823.

The operation control unit 822 may include a register (not illustrated). The register may store information on a period in which a data input/output operation of the memory area 830 is performed in response to the command CMD, i.e., the data input/output period. This period may correspond to the second peak period Peak2 described in FIG. 7. The operation control unit 822 may receive the information on the data input/output period corresponding to the command CMD from the register in response to an activation of the flag signal FLAG, and output second peak generation information PEAK_INFO2 to the clock control unit 824.

The period setting unit 823 may receive the first peak generation information PEAK_INFO1 from the operation control unit 822. Based on the first peak generation information PEAK_INFO1, the period setting unit 823 may output the peak control signal PEAK_CTRL to the command control unit 821.

The clock control unit 824 may receive the flag signal FLAG from the command control unit 821 and activate a clock control signal CLK_CTRL. Furthermore, the clock control unit 824 may receive the second peak generation information PEAK_INFO2 from the operation control unit 822, and activate the clock control signal CLK_CTRL again after the data input/output period.

The data transfer unit 825 may transfer the data DATA received from the interface unit 810 to the memory area 830 during the cache program operation, and may output the data DATA outputted from the memory area 830 to the interface unit 810 during the cache read operation.

The memory area 830 may include a plurality of memory cells (not illustrated) and the page buffer unit 831. The page buffer unit 831 may include a plurality of page buffers (not illustrated) coupled to the memory cells to temporarily store data. Each of the plurality of page buffers may include the cache latch (not illustrated) for the cache operation. The memory area 830 may include busy signal generation unit (not illustrated) to generate the busy signal BUSY. The busy signal generation unit may identify the cache latch of the plurality of page buffers and generate the busy signal BUSY of a ‘high’ level when the cache latch is capable of storing the data DATA. The busy signal generation unit may out the busy signal BUSY to the operation control unit 822.

The memory area 830 may perform the cache operation in response to the operation control signal OP_CTRL.

Next, an operation of the nonvolatile memory device in accordance with the third embodiment of the present invention will be described.

For example, a cache program operation will be described.

The interface unit 810 may receive the first command CMD1 from outside and transfer the first command CMD1 to the command control unit 821. The command control unit 821 may decode the first command CMD1 in response to a deactivation of the peak control signal PEAK_CTRL and output the decoding command DEC_CMD. The operation control unit 822 may receive the decoding command DEC_CMD and generate the first operation control signal OP_CTRL1. In response to the decoding command DEC_CMD, the operation control unit 822 may output the first peak generation information PEAK_INFO1 to the period setting unit 823.

Based on the first peak generation information PEAK_INFO1, the period setting unit 823 may activate the peak control signal PEAK_CTRL for a period corresponding to the first peak generation information PEAK_INFO1. At this time, the first peak generation information PEAK_INFO1 may represent the first peak period Peak1 indicating the loading period of the word lines and the bit lines coupled to the plurality of memory cells of the memory area 830 during the cache program operation corresponding to the first command CMD1.

The data transfer unit 825 may transfer the data DATA received from the interface unit 810 to the memory area 830. The memory area 830 may perform the cache program operation according to the data stored in the cache latch in response to the first operation control signal OP_CTRL1.

During the cache program operation, when the peak current amount increases, the second command CMD2 for the next cache program operation may be received in the command control unit 821.

The command control unit 821 may activate the flag signal FLAG in response to an activation of the peak control signal PEAK_CTRL and the second command CMD2. The command control unit 821 may decode the second command CMD2 and output the decoding command DEC_CMD. The clock control unit 824 may activate the clock control signal CLK_CTRL in response to the activation of the flag signal FLAG. The operation control unit 822 may receive the decoding command DEC_CMD and output the second operation control signal OP_CTRL2 to the memory area 830. In response to the activation of the flag signal FLAG, the operation control unit 822 may output the second peak generation information PEAK_INFO2 on the data input/output period of the memory area 830, corresponding to the decoding command DEC_CMD, to the clock control unit 824.

In response to an activation of the clock control signal CLK_CTRL, the memory area 830 may reduce the frequency of the internal clock signal. In response to the internal clock signal with the changed cycle, the memory area 830 may perform the cache program operations corresponding to the first operation control signal OP_CTRL1 and the second operation control signal OP_CTRL2.

After the data input/output period, the clock control unit 824 may activate the clock control signal CLK_CTRL again based on the second peak generation Information PEAK_INFO2. In response to the activation of the clock control signal CLK_CTRL, the memory area 830 may change the cycle of the internal clock signal to the original cycle. The memory area 830 may perform the cache program operation corresponding to the first command CMD1 in response to the first operation control signal OP_CTRL1 and may perform the next cache program operation corresponding to the second command CMD2 in response to the second operation control signal OP_CTRL2.

When the second command CMD2 is received while the cache program operation corresponding to the first command CMD1 is being performed, the nonvolatile memory device may change the cycle of the internal clock signal, thereby performing the cache program operations corresponding to the first and second command CMD1 and CMD2. That is, during the next cache program operation corresponding to the second command CMD2, when an operation period, i.e., the data input/output period, for the initialization of the cache latch overlaps a peak period, the nonvolatile memory device may change the cycle of the internal clock signal to reduce its frequency, thereby reducing the peak current the nonvolatile memory device consumes.

Hereinafter, a cache read operation will be described.

The interface unit 810 may receive the first command CMD1 from outside and transfer the first command CMD1 to the command control unit 821. The command control unit 821 may decode the first command CMD1 in response to the deactivation of the peak control signal PEAK_CTRL and output the decoding command DEC_CMD. The operation control unit 822 may receive the decoding command DEC_CMD and output the first operation control signal OP_CTRL1. In response to the decoding command DEC_CMD, the operation control unit 822 may output the first peak generation information PEAK_INFO1 to the period setting unit 823.

Based on the first peak generation information PEAK_INFO1, the period setting unit 823 may activate the peak control signal PEAK_CTRL for a period corresponding to the first peak generation information PEAK_INFO1. At this time, the first peak generation information PEAK_INFO1 may represent the first peak period Peak1 indicating the loading period of the word lines and the bit lines coupled to the plurality of memory cells of the memory area 830 during the cache read operation corresponding to the first command CMD1.

The memory area 830 may read data stored in the plurality of cells of the memory area 830 in response to the first operation control signal OP_CTRL1. The read data may be stored in the cache latch. The data transfer unit 825 may receive data DATA stored in the cache latch of the memory area 830 and transfer the data DATA to the interface unit 810.

During the cache read operation, when the peak current amount increases, the second command CMD2 for the next cache read operation may be received in the command control unit 821.

The command control unit 821 may activate the flag signal FLAG in response to the activation of the peak control signal PEAK_CTRL and the second command CMD2. The command control unit 821 may decode the second command CMD2 and output the decoding command DEC_CMD. The clock control unit 824 may activate the clock control signal CLK_CTRL in response to the activation of the flag signal FLAG. The operation control unit 822 may receive the decoding command DEC_CMD and output the second operation control signal OP_CTRL2 to the memory area 830. In response to the activation of the flag signal FLAG, the operation control unit 822 may output the second peak generation information PEAK_INFO2 on the data input/output period of the memory area 830, corresponding to the decoding command DEC_CMD, to the clock control unit 824.

In response to the activation of the clock control signal CLK_CTRL, the memory area 830 may reduce the frequency of the internal clock signal. In response to the internal clock signal with the changed cycle, the memory area 830 may perform the cache read operations corresponding to the first operation control signal OP_CTRL1 and the second operation control signal OP_CTRL2.

After the data input/output period, the clock control unit 824 may activate the clock control signal CLK_CTRL again based on the second peak generation information PEAK_INFO2. In response to the activation of the clock control signal CLK_CTRL, the memory area 830 may change the cycle of the internal clock signal to the original cycle. The memory area 830 may perform the cache read operation corresponding to the first command CMD1 in response to the first operation control signal OP_CTRL1 and may perform the next cache read operation corresponding to the second command CMD2 in response to the second operation control signal OP_CTRL2.

When the second command CMD2 is received while the cache read operation corresponding to the first command CMD1 is being performed, the nonvolatile memory device may change the cycle of the internal clock signal, thereby performing the cache read operations corresponding to the first and second command CMD1 and CMD2. That is, during the next cache read operation corresponding to the second command CMD2, when an operation period, i.e., the data input/output period, for the output of previous data DATA stored in the cache latch overlaps a peak period, the nonvolatile memory device may slow down the cycle of the internal clock signal (i.e. reduce its frequency) of the memory area 830, thereby reducing the peak current consumed by the nonvolatile memory device.

Although various embodiments have been described for illustrative purposes, it will be apparent to those skilled in the art that various changes and modifications may be made without departing from the spirit and scope of the invention as defined in the following claims.

What is claimed is:

1. A nonvolatile memory device comprising:
a memory area suitable for performing a cache operation in response to a command;
a memory controller suitable for setting a peak current period in which current peaks during the cache operation of the memory area; and
a command latch unit suitable for receiving the command, transferring the command to the memory controller, and latching a next command and transferring the next command to the memory controller, after the peak current period, when the next command is received during the peak current period.

2. The nonvolatile memory device of claim 1, wherein the memory controller comprises:
a command decoder suitable for receiving and decoding the command transferred from the command latch unit, and outputting a decoded signal;
an operation control unit suitable for generating a control signal for controlling the cache operation of the memory area and information on the peak current period in response to the decoded signal; and
a period setting unit suitable for receiving the information on the peak current period, and generating a latch activation signal for controlling the command latch unit.

3. The nonvolatile memory device of claim 2, wherein the command latch unit transfers the command to the command decoder when the latch activation signal is deactivated, and latches the command when the latch activation signal is activated.

4. The nonvolatile memory device of claim 1, further comprising:
an interface unit suitable for transferring the command from outside to the command latch unit.

5. The nonvolatile memory device of claim 1, wherein the peak current period includes a current consumption period in which current is consumed in an active and precharge period of a data line during the cache operation of the memory area in response to the command.

6. A nonvolatile memory device comprising:
a memory area suitable for performing a cache operation in response to a command; and
a memory controller suitable for setting a peak current period in which current peaks during the cache operation of the memory area,
wherein the memory controller comprises:
a command control unit suitable for receiving and decoding the command, and generating a flag signal when a next command is applied during the peak current period; and
an operation control unit suitable for activating an operation stop signal for a predetermined period in response to the flag signal,
wherein the memory controller stops the cache operation of the memory area, which is being currently performed, in response to the operation stop signal, and performs the cache operation in response to the next command.

7. The nonvolatile memory device of claim 6, wherein the predetermined period includes a period in which a data input/output operation of the memory area is performed.

8. The nonvolatile memory device of claim 6, wherein the operation control unit generates an operation control signal for controlling the cache operation of the memory area and information on the peak current period in response to a decoded signal from the command control unit.

9. The nonvolatile memory device of claim 8, wherein the memory controller further comprises:
a period setting unit suitable for receiving the information on the peak current period, and generating a peak control signal for controlling the command control unit.

10. The nonvolatile memory device of claim 6, further comprising:
an interface unit suitable for transferring the command from outside to the command control unit.

11. The nonvolatile memory device of claim 6, wherein the peak current period includes a current consumption period in which current is consumed in an active and precharge period of a data line during the cache operation of the memory area in response to the command.

12. A nonvolatile memory device comprising:
a memory area suitable for performing a cache operation in response to a command in synchronization with an internal clock signal; and
a memory controller suitable for setting a first peak current period in which current peaks during the cache operation of the memory area,
wherein the memory controller comprises:
a command control unit suitable for receiving and decoding the command, and generating a flag signal when a next command is applied during the first peak current period; and
a clock control unit suitable for generating a first clock control signal in response to the flag signal,
wherein the memory controller adjusts a cycle of the Internal clock signal in response to the first clock control signal.

13. The nonvolatile memory device of claim 12, wherein the memory controller further comprises:
an operation control unit suitable for generating an operation control signal for controlling the cache operation of the memory area and information on the first peak current period in response to a decoded signal from the command control unit; and
a period setting unit suitable for receiving the information on the first peak current period, and generating a peak control signal for controlling the command control unit.

14. The nonvolatile memory device of claim 13, wherein the operation control unit outputs information on a second peak current period in which current peaks during the cache operation of the memory area, to the clock control unit in response to the flag signal.

15. The nonvolatile memory device of claim 14, wherein the clock control unit receives the information on the second peak current period and outputs a second clock control signal, and adjusts the cycle of the internal clock signal in response to the second clock control signal.

16. The nonvolatile memory device of claim 14, wherein the first peak current period includes a current consumption period in which current is consumed in an active and precharge period of a data line during the cache operation of the memory area in response to the command, and the second peak current period includes a current consumption period in which current is consumed in a period in which a data input/output operation is performed, during the cache operation of the memory area in response to the command.

17. The nonvolatile memory device of claim 12, further comprising:
an interface unit suitable for transferring the command from outside to the command control unit.

18. An operating method of a nonvolatile memory device, comprising:
performing a cache operation in response to a first command;
setting a peak current period in which current peaks during the cache operation;
latching a second command when the second command is received during the peak current period; and
performing a data input/output operation in response to the latched second command after the peak current period.

19. The operating method of claim 18, wherein the peak current period includes a current consumption period in which current is consumed in an active and precharge period of a data line during the cache operation.

20. An operating method of a nonvolatile memory device, comprising:
performing a cache operation in response to a first command;
setting a peak current period in which current peaks during the cache operation; and
generating a flag signal when a second command is received during the peak current period.

21. The operating method of claim 20, further comprising:
stopping the cache operation in response to the flag signal;
performing a cache operation corresponding to the second command for a predetermined period in response to the flag signal; and
performing the cache operation corresponding to the first command after the predetermined period.

22. The operating method of claim 20, further comprising:
setting a cycle of a clock signal for a predetermined period in response to the flag signal;
performing the cache operation corresponding to the first command and a cache operation corresponding to the second command in response to the set cycle of the clock signal; and
resetting the cycle of the clock signal after the predetermined period.
